(19) United States
(12) Patent Application Publication
(10) Pub. No.: US 2024/0338940 A1
(43) Pub. Date: Oct. 10, 2024

(54) CORRECTION DEVICE, CORRECTION PROGRAM STORAGE MEDIUM, AND CORRECTION SYSTEM

(71) Applicant: MITSUBISHI ELECTRIC CORPORATION, Tokyo (JP)

(72) Inventors: Tetsuro Nishioka, Tokyo (JP); Takuya Taniguchi, Tokyo (JP)

(73) Assignee: MITSUBISHI ELECTRIC CORPORATION, Tokyo (JP)

(21) Appl. No.: 18/427,163

(22) Filed: Jan. 30, 2024

(30) Foreign Application Priority Data
Apr. 5, 2023 (JP) 2023-061060

(51) Int. Cl. G06V 10/98; G06V 10/776; G06V 20/58

(52) U.S. Cl. CPC G06V 10/98; G06V 10/776; G06V 20/58; G06V 2201/08

(57) ABSTRACT

Included are: an object detection information acquiring unit that acquires object detection information regarding an object detected by a sensor in a target area, the object detection information including information on a state-related item related to a state of the object; a correction unit that corrects the information on the state-related item included in the object detection information on the basis of the object detection information acquired by the object detection information acquiring unit and correction information for correcting the information on the state-related item, and generates object information that is the corrected object detection information; and an object information output unit that outputs the object information generated by the correction unit.

### TECHNICAL FIELD

The present disclosure relates to a correction device, a correction program storage medium, and a correction system that correct information regarding an object detected by a sensor (hereinafter, referred to as “object detection information”).

### BACKGROUND ART

In recent years, a technique of performing various functions such as automatic driving of a vehicle has been developed using object detection information obtained by a sensor such as a camera or a LiDAR detecting an object.

By the way, for example, Patent Literature 1 discloses a technique of detecting an object included in an input image imaged by a monitoring camera, and determining a type of the object included in the input image on the basis of a probability for each type of the object obtained by inputting movement history information on the detected object to a learned model, thereby quickly and accurately determining the type of the object in a case where the number of pixels related to the object included in the input image is small.

### CITATION LIST

### Patent Literatures

Patent Literature 1: JP 2020-21111 A

### SUMMARY OF INVENTION

### Technical Problem

In a conventional technique, there is a problem that object detection information obtained by a sensor detecting an object does not necessarily have sufficient reliability to be used in a technique that performs various functions.

For example, in a case where sensor arrangement intervals are sparse or in a case where a distance from a sensor to an object is long, accuracy of object detection information obtained by the sensor detecting the object may be low, and reliability of the object recognizable from the object detection information may be low.

Note that, in a conventional technique as disclosed in Patent Literature 1, by preparing a learned model in advance so as to obtain reliable information (probability for each type) even when an input image having a small number of pixels related to an object included in an input image, in other words, an input image having low reliability is input, the low reliability of the input image is compensated, and the input image itself is not information having sufficient reliability. Therefore, the conventional technique as disclosed in Patent Literature 1 still cannot solve the above problem.

The present disclosure has been made in order to solve the above-described problem, and an object of the present disclosure is to provide a correction device capable of correcting object detection information obtained by a sensor detecting an object to information having sufficient reliability to be used in a technique that performs various functions.

### Solution to Problem

A correction device according to the present disclosure includes: processing circuitry performing: to acquire object detection information regarding an object detected by a sensor in a target area, the object detection information including information on a state-related item related to a state of the object; to correct the information on the state-related item included in the object detection information on a basis of the object detection information acquired and correction information for correcting the information on the state-related item, and to generate object information that is the corrected object detection information; and to output the object information generated.

### Advantageous Effects of Invention

According to the present disclosure, a correction device can correct object detection information obtained by a sensor detecting an object to information having sufficient reliability to be used in a technique that performs various functions.

### BRIEF DESCRIPTION OF DRAWINGS

FIG. 1 is a diagram illustrating a configuration example of a correction device according to a first embodiment.

FIG. 2 is a diagram illustrating a detailed configuration example of a correction unit included in the correction device according to the first embodiment.

FIG. 3 is a diagram illustrating a flow of information transferred between components in the correction device according to the first embodiment.

FIG. 4 is a flowchart for explaining an operation of the correction device according to the first embodiment.

FIG. 5 is a flowchart for explaining details of a process in step ST3 of FIG. 4.

FIG. 6 is a diagram for explaining an example of an operation of the correction device as described with reference to the flowchart of FIG. 4 in a case where the correction device is applied in the above scene.

FIGS. 7A and 7B are each a diagram illustrating an example of a hardware configuration of the correction device according to the first embodiment.

### DESCRIPTION OF EMBODIMENTS

Hereinafter, an embodiment of the present disclosure will be described in detail with reference to the drawings.

### First Embodiment

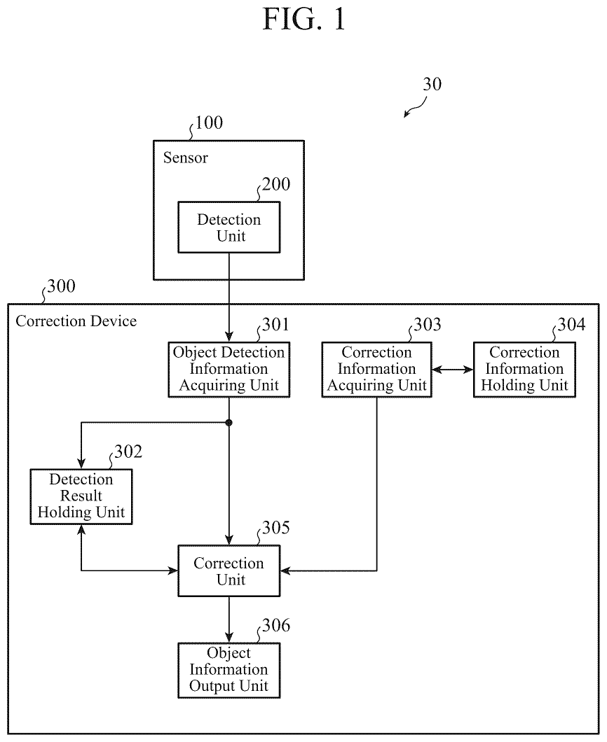

FIG. 1 is a diagram illustrating a configuration example of a correction device 300 according to a first embodiment.

The correction device 300 is connected to a sensor 100. The correction device 300 and the sensor 100 constitute a correction system 30.

The sensor 100 detects an object present in an object detection target area (hereinafter, referred to as “target area”).

The sensor 100 is, for example, a light detection and ranging (LiDAR), a radio wave sensor such as a millimeter wave radar, or a camera. The sensor 100 only needs to be a sensor capable of detecting an object present in the periphery.

Note that only one sensor 100 is illustrated in FIG. 1, but this is merely an example. The correction system 30 may include a plurality of sensors 100. When the plurality of sensors 100 is included, the plurality of sensors 100 may be different types of sensors 100.

The sensor 100 includes a detection unit 200. The detection unit 200 generates information regarding an object detected by the sensor 100 (hereinafter, referred to as “object detection information”). Specifically, for example, in a case where the sensor 100 is an infrared camera, the detection unit 200 performs an image recognition process with an RGB image acquired by the sensor 100 as an input, acquires a position of an object imaged in the RGB image, a type of the object, and the like, and generates object detection information. Information when the sensor 100 detects an object has a format specific to a type of the sensor 100. The detection unit 200 generates object detection information by using this information as abstracted information.

The object detection information includes an identifier capable of specifying the sensor 100 that has detected an object indicated by the object detection information, environment information at the moment when the sensor 100 has detected the object, and information regarding a state of the object (hereinafter, referred to as “object state information”).

The identifier is, for example, an ID (for example, “001”) uniquely determined for each sensor 100 that has detected the object.

The environment information is, for example, information indicating a position where the sensor 100 is disposed.

The object state information includes information on one or more items related to a state of the object (hereinafter, referred to as “state-related item”). Examples of the state-related item include a position of the object, a distance to the object, a speed of the object, a size of the object, a type of the object, and an orientation of the object.

The detection unit 200 outputs the generated object detection information to the correction device 300.

Note that, in FIG. 1, the sensor 100 includes the detection unit 200, but this is merely an example. The correction device 300 may include the detection unit 200, or a device connected to the sensor 100 and the correction device 300, such as a personal computer (PC), may include the detection unit 200 outside the sensor 100.

The correction device 300 is, for example, mounted on a server and is connected to the sensor 100 via a network.

The correction device 300 corrects the object detection information regarding an object detected by the sensor 100 in a target area, in other words, the object detection information output from the sensor 100 as necessary.

Specifically, the correction device 300 corrects information on a state-related item to be corrected (hereinafter, referred to as “correction target state-related item”) in the information on the state-related items of the object state information included in the object detection information as necessary. Specifically, the correction device 300 corrects information on a correction target state-related item for which it is determined that a value with low reliability is recorded in the information on the state-related items of the object state information included in the object detection information with correction information (details of which will be described later) or a history of the object detection information. Which state-related item is used as the correction target state-related item is appropriately determined in advance.

The state-related item that can be the correction target state-related item is, for example, an item indicating unchanged information that does not change depending on movement of the object or a change in position of the sensor 100. Examples of the state-related item that can be the correction target state-related item include a size of the object and a type of the object. For example, if it is assumed that the object detected by the sensor 100 is a vehicle and the vehicle necessarily travels along a road, an orientation of the vehicle can also be the correction target state-related item.

Details of the correction device 300 will be described later.

In the following first embodiment, as an example, the sensor 100 is a LiDAR. By emitting light to a target area that is a three-dimensional space and detecting light (reflected light) that is obtained by the emitted light being reflected by an object present in the target area, the LiDAR detects a distance to the object present in the target area, a property of the object, and the like.

In addition, the sensor 100 is disposed, for example, on a road shoulder of a road and detects a mobile object traveling on the road, such as a vehicle. In the following description, when an “object” is referred to, a “mobile object traveling on a road, such as a vehicle” is assumed.

The information regarding the object detected by the sensor 100 is output to the detection unit 200 as point cloud data. The detection unit 200 generates object detection information on the basis of the point cloud data.

In addition, in the following first embodiment, as an example, the object state information of the object detection information regarding an object detected by the sensor 100 includes information on four state-related items of a position of the object, a size of the object, an orientation of the object, and a type of the object.

The correction device 300 corrects information on a correction target state-related item for which it is determined that a value with low reliability is recorded in the information on the four state-related items included in the object detection information obtained from the detection unit 200 with correction information or a history of the object detection information, and generates the corrected object detection information as object information.

In the following first embodiment, as an example, the orientation of the object is the correction target state-related item among the four state-related items (the position of the object, the size of the object, the orientation of the object, and the type of the object).

The correction device 300 outputs the generated object information.

For example, the correction device 300 outputs the generated object information to a driving control device (not illustrated) and a navigation device (not illustrated) mounted on a vehicle. The vehicle is assumed to be a vehicle having an automatic driving function (hereinafter, referred to as “automatic driving vehicle”). The driving control device of the automatic driving vehicle can recognize an object (for example, an obstacle that obstructs traveling of the automatic driving vehicle) on the basis of the object information and map information, and perform driving control so as to pass an area where the obstacle is present even in a case where a peripheral cognitive sensor or the like is not mounted.

For example, the navigation device may superimpose an obstacle based on the object information on a map and display the obstacle on a display device (not illustrated) included in the navigation device. An occupant of the automatic driving vehicle can recognize the obstacle by looking at the display device.

Here, it is assumed that the correction device 300 outputs the object detection information to the automatic driving vehicle without correction. At this time, for example, the sensor 100 detects an orientation of an obstacle in an orientation obviously different from an actual orientation, or the sensor 100 detects a size of the obstacle as a size obviously larger than an actual size.

In this case, in the automatic driving vehicle, the driving control device controls the automatic driving vehicle on the basis of the object detection information so as to pass an area where an obstacle of an obviously wrong orientation or an obviously too huge size is present. As a result, there is a problem that the automatic driving vehicle cannot necessarily pass an area where an obstacle is actually present.

In addition, for example, the navigation device displays the obstacle on a map in a superimposed manner with an obviously wrong orientation or an obviously too huge size on the basis of the object detection information. In a case where the orientation or size of the obstacle superimposed on the map is obviously wrong, there is a problem that a driver may erroneously recognize the orientation or size of the obstacle.

Meanwhile, in the first embodiment, the correction device 300 outputs object information obtained by correcting the object detection information. The driving control device can recognize an obstacle on the basis of the object information output from the correction device 300 and map information, and can control the automatic driving vehicle so as to pass an area where the obstacle is present. The navigation device displays a map on which the obstacle is displayed in a superimposed manner on the basis of the object information output from the correction device 300 and the map information. As a result, the automatic driving vehicle can pass the area where the obstacle is present without the above-described problem. In addition, a driver of the automatic driving vehicle can recognize the obstacle in an actual orientation or size.

As illustrated in FIG. 1, the correction device 300 includes an object detection information acquiring unit 301, a detection result holding unit 302, a correction information acquiring unit 303, a correction information holding unit 304, a correction unit 305, and an object information output unit 306.

The object detection information acquiring unit 301 acquires the object detection information from the detection unit 200.

The object detection information acquiring unit 301 outputs the acquired object detection information to the correction unit 305 and stores the object detection information in the detection result holding unit 302.

The object detection information acquiring unit 301 stores the object detection information in the detection result holding unit 302 in association with an acquisition date and time and an identifier of the object detection information.

The detection result holding unit 302 stores the object detection information acquired by the object detection information acquiring unit 301 as a history.

The detection result holding unit 302 stores the object detection information according to a preset condition (hereinafter, referred to as “history holding condition”). As the history holding condition, for example, a predetermined time or a predetermined number of cases is set by an administrator or the like. The detection result holding unit 302 stores, for example, the object detection information for a predetermined time or the object detection information for a predetermined number of cases according to the history holding condition.

Note that, in FIG. 1, the detection result holding unit 302 is included in the correction device 300, but this is merely an example. The detection result holding unit 302 may be disposed at a place that can be referred to by the correction device 300 outside the correction device 300.

The correction information acquiring unit 303 acquires correction information from information held in the correction information holding unit 304 (hereinafter, referred to as “correction information generating information”).

The correction information is information for correcting the object detection information. More specifically, the correction information is information for correcting information on a correction target state-related item in the information on the state-related items included in the object state information of the object detection information. In the first embodiment, as an example, the correction target state-related item is an orientation of the object, and therefore the correction information is information for correcting the orientation of the object.

The correction information may be, for example, information indicating an absolute value capable of directly replacing information on the correction target state-related item or information indicating a relative value with respect to the information on the correction target state-related item. In addition, the correction information may be, for example, information of a dictionary-type array in which the information on the correction target state-related item is used as a key and a variable to be replaced with the information on the correction target state-related item is associated with the key.

The correction information generating information held by the correction information holding unit 304 is, for example, map information.

For example, by generating correction information on the basis of the correction information generating information held by the correction information holding unit 304 and the object detection information, the correction information acquiring unit 303 acquires the correction information. The correction information acquiring unit 303 only needs to acquire the object detection information from the object detection information acquiring unit 301. Note that, in FIG. 1, an arrow from the object detection information acquiring unit 301 to the correction information acquiring unit 303 is not illustrated.

As a specific example, the object detection information includes information on a position of the object. The correction information acquiring unit 303 refers to the map information held by the correction information holding unit 304 and determines a road shape corresponding to the position of the object in the object detection information. The map information includes information on the road shape. The correction information acquiring unit 303 estimates an orientation of the object on the basis of the map information and the road shape corresponding to the position of the object. Then, the correction information acquiring unit 303 generates information regarding the estimated orientation of the object and acquires the information as correction information.

Note that this is merely an example, and for example, the correction information holding unit 304 holds information that can be used as the correction information, and the correction information acquiring unit 303 may acquire the information held by the correction information holding unit 304 as the correction information.

For example, a developer, a user, or the like of the correction device 300 generates correction information in advance on the basis of a geographic situation regarding the target area, a feature of an object (here, a vehicle) to be detected by the sensor 100, or the like, and stores the correction information in the correction information holding unit 304. For example, if the target area is a factory area, most of vehicles detected by the sensor 100 are trucks. The developer, the user, or the like of the correction device 300 generates the correction information in consideration of the fact that the target area is a factory area and most of the vehicles are trucks.

The correction information acquiring unit 303 outputs the acquired correction information to the correction unit 305.

The correction information holding unit 304 stores information that can be used as the correction information or the correction information generating information (for example, map information).

Note that, in FIG. 1, the correction information holding unit 304 is included in the correction device 300, but this is merely an example. The correction information holding unit 304 may be disposed at a place that can be referred to by the correction device 300 outside the correction device 300.

In a case where the correction information holding unit 304 holds the correction information, the correction information held by the correction information holding unit 304 may include information for correcting information on a state-related item other than the correction target state-related item. The correction information only needs to include information for correcting information on the correction target state-related item.

That is, in the first embodiment, the correction information only needs to include at least information for correcting the orientation of the object.

In a case where the correction information held by the correction information holding unit 304 includes information other than the information for correcting the information on the correction target state-related item, the correction information acquiring unit 303 extracts information for correcting the information on the correction target state-related item from the correction information held by the correction information holding unit 304, and acquires the information as correction information.

The correction unit 305 corrects the information on the state-related item included in the object detection information on the basis of the object detection information acquired by the object detection information acquiring unit 301, the correction information acquired by the correction information acquiring unit 303, and a history of the object detection information acquired by the object detection information acquiring unit 301, in other words, a history of the object detection information stored in the detection result holding unit 302, and generates object information.

In the first embodiment, the correction unit 305 corrects the information on the orientation of the object included in the object detection information on the basis of the object detection information, the correction information, and the history of the object detection information, and generates object information.

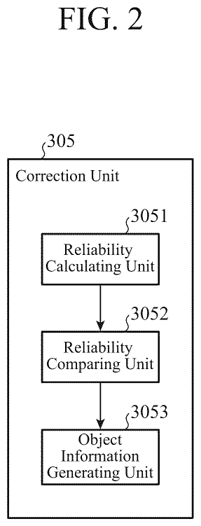

Here, FIG. 2 is a diagram illustrating a detailed configuration example of the correction unit 305 included in the correction device 300 according to the first embodiment.

The correction unit 305 includes a reliability calculating unit 3051, a reliability comparing unit 3052, and an object information generating unit 3053.

The reliability calculating unit 3051 calculates reliability of the information on the state-related item included in the object detection information acquired by the object detection information acquiring unit 301 (hereinafter, referred to as “first reliability”), reliability of the correction information (hereinafter, referred to as “second reliability”), and reliability of the information on the state-related item included in the history of the object detection information (hereinafter, referred to as “third reliability”). The first reliability, the second reliability, and the third reliability are represented by, for example, values of “0.0” to “1.0”.

More specifically, the reliability calculating unit 3051 calculates the first reliability of the information on the correction target state-related item included in the object detection information, the second reliability of the information on the correction target state-related item indicated by the correction information, and the third reliability of the information on the correction target state-related item included in the history of the object detection information. In the first embodiment, the reliability calculating unit 3051 calculates the first reliability of the information on the orientation of the object included in the object detection information, in other words, the orientation of the object detected by the sensor 100, the second reliability of the information for correcting the orientation of the object, and the third reliability of the history of the information on the orientation of the object included in the object detection information, in other words, the orientation of the object detected by the sensor 100.

In the first embodiment, the process of calculating the first reliability, the second reliability, and the third reliability performed by the reliability calculating unit 3051 is also referred to as “reliability calculating process”.

The reliability calculating unit 3051 calculates a high value for each of the first reliability, the second reliability, and the third reliability in such a manner that it can be estimated that a value indicated by information on the correction target state-related item of the object detection information, information corresponding to the information on the correction target state-related item in the correction information, or information on the correction target state-related item of the history of the object detection information is closer to a true value.

The reliability calculating unit 3051 only needs to acquire the history of the object detection information from the detection result holding unit 302. At this time, the reliability calculating unit 3051 associates an identifier assigned to the object detection information acquired by the object detection information acquiring unit 301 with an identifier assigned to the object detection information stored in the detection result holding unit 302, and acquires matched object detection information from the detection result holding unit 302.

Here, a method for calculating the first reliability, the second reliability, and the third reliability by the reliability calculating unit 3051 will be described.

First, a method for calculating the second reliability by the reliability calculating unit 3051 will be described with an example.

In the first embodiment, a value to be calculated as the second reliability by the reliability calculating unit 3051 is determined in advance. For example, when a developer, a user, or the like of the correction device 300 generates the correction information in advance, the second reliability is associated with information corresponding to the correction target state-related item in the correction information. For example, if the developer, the user, or the like of the correction device 300 finds that the orientation of the object is substantially “south”, the developer, the user, or the like sets information indicating “south” as the information on the orientation in the correction information, and associates the second reliability “0.8” with the information indicating “south”. The reliability calculating unit 3051 uses “0.8” as a value calculated as the second reliability from the correction information. For example, the reliability calculating unit 3051 may store the second reliability for each correction target state-related item determined in advance by the developer, the user, or the like of the correction device 300 in a buffer or the like of the reliability calculating unit 3051. In this case, the reliability calculating unit 3051 only needs to extract the second reliability stored in advance from the buffer or the like.

For example, a condition for calculating the second reliability may be set in advance by the developer, the user, or the like of the correction device 300 and stored in the buffer of the reliability calculating unit 3051. In this case, the reliability calculating unit 3051 only needs to calculate the second reliability according to the preset condition.

As described above, the reliability calculating unit 3051 calculates the second reliability so as to be a value determined in advance by the developer, the user, or the like of the correction device 300. The second reliability is determined depending on certainty, in other words, in such a manner that the second reliability is such a large value that the second reliability can be estimated to be close to a true value.

Next, a method for calculating the first reliability by the reliability calculating unit 3051 will be described with an example.

The reliability calculating unit 3051 also calculates the first reliability in such a manner that the first reliability is a larger value as information on the correction target state-related item is more probable. For example, as a distance to an object to be detected is shorter, it is assumed that the sensor 100 can capture a feature of the object more accurately. In other words, as the distance from the sensor 100 to the object to be detected is shorter, it is assumed that a feature of the object detected by the sensor 100 is closer to a true value. This is because an error or noise tends to occur more often in the detected information as the distance from the sensor 100 to the object is longer. Therefore, for example, the reliability calculating unit 3051 calculates the first reliability in such a manner that the first reliability is a larger value as the distance between the sensor 100 and the object is shorter. Note that the object detection information includes the object state information including the information on the position of the object and the environment information indicating the position where the sensor 100 is disposed, and therefore the reliability calculating unit 3051 can calculate the distance between the sensor 100 and the object on the basis of the object detection information.

A condition on what value is calculated as the first reliability by the reliability calculating unit 3051 at a certain distance between the sensor 100 and the object is determined in advance by the developer, the user, or the like of the correction device 300, and is stored in the buffer or the like of the reliability calculating unit 3051. The developer, the user, or the like of the correction device 300 determines the condition for calculating the first reliability while considering a determination condition of the second reliability.

Specifically, the developer, the user, or the like of the correction device 300 determines the condition for calculating the first reliability in such a manner that the information on the correction target state-related item included in the object detection information, here, the information on the orientation of the object is corrected with the correction information when it is assumed that the information on the orientation of the object should be corrected. Specifically, the developer, the user, or the like of the correction device 300 determines the condition for calculating the first reliability in such a manner that the first reliability is calculated to be larger than the second reliability when it is assumed that the information on the correction target state-related item included in the object detection information should be corrected. The time when it is assumed that the information on the correction target state-related item included in the object detection information should be corrected is, for example, a time when the distance from the sensor 100 to the object is short (for example, shorter than a preset distance).

Therefore, in the first embodiment, the second reliability is not a value indicating whether the information itself corresponding to the information on the correction target state-related item in the correction information is reliable, but can be said to be a value used to control weighting on whether or not to correct the information on the correction target state-related item included in the object detection information. Next, a method for calculating the third reliability by the reliability calculating unit 3051 will be described with an example.

For example, in a case where the reliability (first reliability) associated with the information on the correction target state-related item included in the history of the object detection information is equal to or more than a preset threshold (hereinafter, referred to as “first reliability determining threshold”), the reliability calculating unit 3051 calculates the third reliability corresponding to the information on the correction target state-related item in the history of the object detection information associated with reliability equal to or more than the first reliability determining threshold to be high. Note that when calculating the first reliability, the reliability calculating unit 3051 stores the calculated first reliability in association with the information on the correction target state-related item corresponding to the first reliability in the object detection information stored in the detection result holding unit 302. The reliability calculating unit 3051 can specify the information on the correction target state-related item corresponding to the first reliability on the basis of an identifier assigned to the object detection information and an acquisition date and time of the object detection information.

For example, the reliability calculating unit 3051 extracts the largest value from values of the first reliability associated with the information on the correction target state-related item included in the plurality of pieces of object detection information included in the history. Then, the reliability calculating unit 3051 calculates the third reliability by comparing the extracted first reliability with the first reliability determining threshold.

For example, the reliability calculating unit 3051 may calculate the third reliability by comparing an average value of the first reliability associated with the information on the correction target state-related item included in the plurality of pieces of object detection information included in the history with the first reliability determining threshold.

Note that, in a case where there is a plurality of correction target state-related items, the reliability calculating unit 3051 calculates the first reliability and the third reliability for each piece of information on the correction target state-related items. In addition, the reliability calculating unit 3051 calculates the second reliability for each piece of information corresponding to the information on the correction target state-related item included in the correction information.

The reliability calculating unit 3051 outputs information regarding the first reliability (hereinafter, referred to as “first reliability information”), information regarding the second reliability (hereinafter, referred to as “second reliability information”), and information regarding the third reliability (hereinafter, referred to as “third reliability information”) to the reliability comparing unit 3052.

The first reliability information is information in which the information on the correction target state-related item of the object detection information is associated with the first reliability. In a case where there is a plurality of the correction target state-related items, information on the correction target state-related item is associated with the corresponding first reliability for each of the correction target state-related items.

The second reliability information is information in which the information corresponding to the information on the correction target state-related item in the correction information is associated with the second reliability. In a case where there is a plurality of pieces of information corresponding to the correction target state-related item, information corresponding to the correction target state-related item is associated with the corresponding second reliability for each piece of information corresponding to the correction target state-related item.

The third reliability information is information in which the information on the correction target state-related item of the history of the object detection information is associated with the third reliability.

Note that the reliability calculating unit 3051 outputs, to the reliability comparing unit 3052, the object detection information output from the object detection information acquiring unit 301, the correction information acquired from the correction information acquiring unit 303, and the history of the object detection information acquired from the detection result holding unit 302 together with the first reliability information, the second reliability information, and the third reliability information.

By comparing the first reliability, the second reliability, and the third reliability calculated by the reliability calculating unit 3051, the reliability comparing unit 3052 determines whether or not to correct the state-related item included in the object detection information acquired by the object detection information acquiring unit 301, more specifically, the information on the correction target state-related item with the correction information or the state-related item included in the history of the object detection information, more specifically, the information on the correction target state-related item.

In the first embodiment, the process of determining whether or not to correct the information on the state-related item included in the object detection information with the correction information or the information on the state-related item included in the history of the object detection information by comparing the first reliability, the second reliability, and the third reliability, performed by the reliability comparing unit 3052, is also referred to as “reliability comparing process”.

For example, in a case where the second reliability or the third reliability is higher than the first reliability as a result of comparing the first reliability, the second reliability, and the third reliability, the reliability comparing unit 3052 determines that the information on the correction target state-related item included in the object detection information should be corrected.

The reliability comparing unit 3052 selects information that is a calculation source of the highest reliability among the first reliability, the second reliability, and the third reliability.

For example, in a case where the second reliability is the highest, the reliability comparing unit 3052 selects information corresponding to the information on the correction target state-related item that is a calculation source of the second reliability in the correction information. In the first embodiment, since the correction target state-related item is the orientation of the object, for example, in a case where the second reliability is the highest, the reliability comparing unit 3052 selects information corresponding to the orientation of the object that is a calculation source of the second reliability in the correction information.

For example, in a case where the third reliability is the highest, the reliability comparing unit 3052 selects the information on the correction target state-related item of the history of the object detection information. In the first embodiment, since the correction target state-related item is the orientation of the object, the reliability comparing unit 3052 selects information indicating the orientation of the object that is a calculation source of the third reliability in the history of the object detection information.

For example, in a case where a preset condition (hereinafter, referred to as “correction necessity determining condition”) is satisfied, the reliability comparing unit 3052 determines that the information on the correction target state-related item included in the object detection information should be corrected. Here, in a case where the correction necessity determining condition is satisfied, the reliability comparing unit 3052 determines that the information on the orientation of the object included in the object detection information should be corrected.

For example, the following condition is set as the correction necessity determining condition.

The first reliability is less than a preset threshold (hereinafter, referred to as “reliability determining threshold”), and the second reliability or the third reliability is equal to or more than the reliability determining threshold.

The correction necessity determining condition is set in advance by a developer, a user, or the like of the correction device 300, and is stored in a place that can be referred to by the correction device 300.

The reliability comparing unit 3052 selects information that is a calculation source of the reliability (the second reliability or the third reliability) equal to or more than the reliability determining threshold.

For example, when only the second reliability is equal to or more than the reliability determining threshold, the reliability comparing unit 3052 selects information for correcting the orientation of the object, which is a calculation source of the second reliability, in the correction information.

The reliability comparing unit 3052 outputs the selected information to the object information generating unit 3053 as a reliability comparing result in association with information capable of specifying to which piece of correction target state-related item information in the object detection information the selected information corresponds.

Note that in a case where the reliability comparing unit 3052 determines that correction of the information on the correction target state-related item is unnecessary, the reliability comparing unit 3052 outputs information indicating the determination to the object information generating unit 3053 as a reliability comparing result.

On the basis of the determination result as to whether or not to correct the state-related item included in the object detection information acquired by the object detection information acquiring unit 301, more specifically, the information on the correction target state-related item with the correction information or the state-related item included in the history of the object detection information, more specifically, the information on the correction target state-related item, made by the reliability comparing unit 3052, the object information generating unit 3053 corrects the state-related item included in the object detection information, more specifically, the information on the correction target state-related item on the basis of the correction information or the state-related item included in the history of the object detection information, more specifically, the information on the correction target state-related item, and generates object information.

Specifically, in a case where the information selected by the reliability comparing unit 3052 is output from the reliability comparing unit 3052, the object information generating unit 3053 performs correction to rewrite the information on the correction target state-related item included in the object detection information acquired by the object detection information acquiring unit 301 with the information output from the reliability comparing unit 3052.

In the first embodiment, for example, in a case where the reliability comparing unit 3052 selects the information corresponding to the orientation of the object, which is a calculation source of the second reliability, the object information generating unit 3053 performs correction to rewrite the information on the orientation of the object included in the object detection information acquired by the object detection information acquiring unit 301 with the information corresponding to the orientation of the object, which is the calculation source of the second reliability, that is, the information corresponding to the orientation of the object in the correction information. For example, in a case where the reliability comparing unit 3052 selects the information on the orientation of the object, which is a calculation source of the third reliability, the object information generating unit 3053 performs correction to rewrite the information on the orientation of the object included in the object detection information acquired by the object detection information acquiring unit 301 with the information on the orientation of the object, which is the calculation source of the third reliability, that is, the information on the orientation of the object in the history of the object detection information.

The object information generating unit 3053 uses the corrected object detection information as object information.

Note that, for example, in a case where a plurality of pieces of selected information is output from the reliability comparing unit 3052 as information corresponding to information of a certain correction target state-related item, the object information generating unit 3053 rewrites the information on the correction target state-related item included in the object detection information with a value converted from values indicated by the plurality of pieces of selected information, such as an average value of values indicated by the plurality of pieces of selected information.

For example, when rewriting the information on the correction target state-related item in the object detection information, the object information generating unit 3053 may perform a calculation process such as rewriting the information with a median value with the object detection information instead of rewriting the information with a value as it is of information corresponding to the correction target state-related item in the correction information or information corresponding to the correction target state-related item in the history of the object detection information.

For example, a calculation process with a median value between information corresponding to the correction target state-related item in the object detection information and information corresponding to the correction target state-related item in the correction information may be performed when the correction information acquiring unit 303 generates the correction information. The correction information acquiring unit 303 calculates a median value or the like by performing the calculation process, and acquires correction information by generating correction information including the calculated median value or the like.

The object information generating unit 3053 outputs the generated object information to the object information output unit 306.

The object information output unit 306 outputs the object information generated by the object information generating unit 3053 to an external device.

As described above, the external device to which the object information output unit 306 outputs the object information is, for example, a driving control device or a navigation device mounted on an automatic driving vehicle. The external device may be, for example, a display device included in a management device (not illustrated) such as a PC that monitors a target area in a management room or the like.

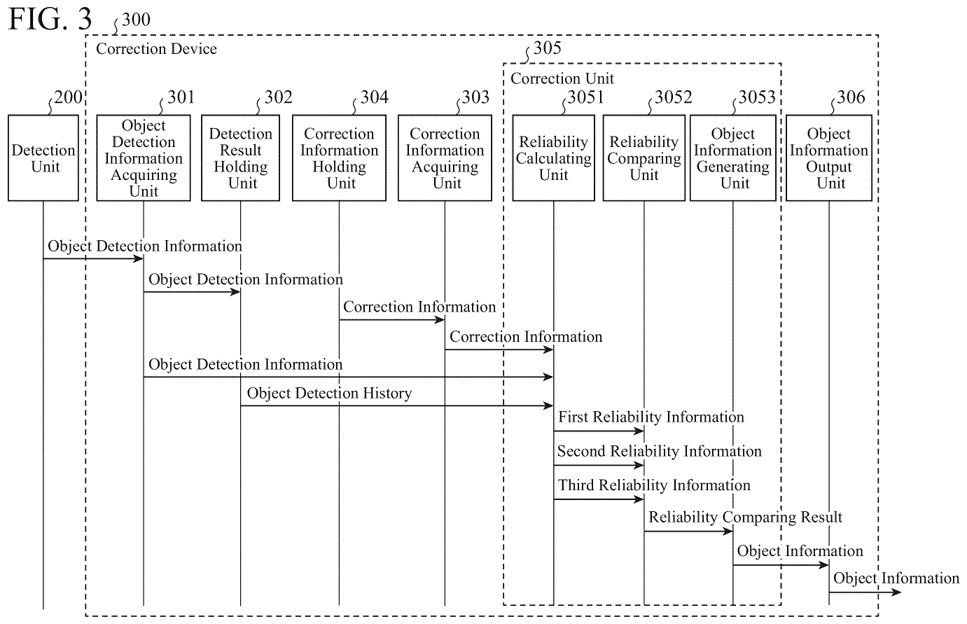

FIG. 3 is a diagram illustrating a flow of information transferred between components in the correction device 300 according to the first embodiment.

Note that, for the sake of convenience, in the correction unit 305, the object detection information, the correction information, and the history of the object detection information output from the reliability calculating unit 3051 to the reliability comparing unit 3052, and the object detection information, the correction information, and the history of the object detection information output from the reliability comparing unit 3052 to the object information generating unit 3053 are not illustrated.

An operation of the correction device 300 according to the first embodiment will be described.

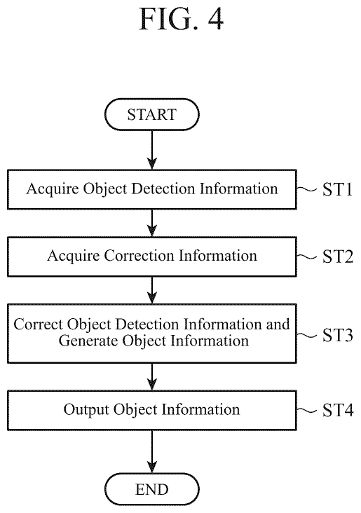

FIG. 4 is a flowchart for explaining the operation of the correction device 300 according to the first embodiment.

The object detection information acquiring unit 301 acquires object detection information from the detection unit 200 (step ST1).

The object detection information acquiring unit 301 outputs the object detection information acquired in step ST1 to the correction unit 305, and stores the object detection information in the detection result holding unit 302.

The correction information acquiring unit 303 acquires correction information (step ST2).

The correction information acquiring unit 303 outputs the acquired correction information to the correction unit 305.

The correction unit 305 corrects information on a state-related item included in the object detection information on the basis of the object detection information acquired by the object detection information acquiring unit 301 in step ST1, the correction information acquired by the correction information acquiring unit 303 in step ST2, and a history of the object detection information acquired by the object detection information acquiring unit 301, in other words, the history of the object detection information stored in the detection result holding unit 302, and generates object information (step ST3).

The object information output unit 306 outputs the object information generated by the correction unit 305 in step ST3 (step ST4).

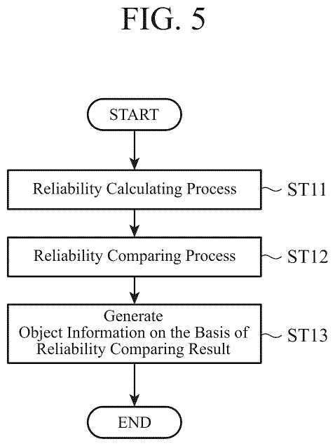

FIG. 5 is a flowchart for explaining details of the process in step ST3 of FIG. 4.

The reliability calculating unit 3051 performs a reliability calculating process of calculating the first reliability, the second reliability, and the third reliability (step ST11).

The reliability calculating unit 3051 outputs the first reliability information, the second reliability information, and the third reliability information to the reliability comparing unit 3052.

Note that the reliability calculating unit 3051 outputs, to the reliability comparing unit 3052, the object detection information output from the object detection information acquiring unit 301, the correction information acquired from the correction information acquiring unit 303, and the history of the object detection information acquired from the detection result holding unit 302 together with the first reliability information, the second reliability information, and the third reliability information. By comparing the first reliability, the second reliability, and the third reliability calculated by the reliability calculating unit 3051 in step ST11, the reliability comparing unit 3052 performs a reliability comparing process of determining whether or not to correct the state-related item included in the object detection information acquired by the object detection information acquiring unit 301, more specifically, the information on the correction target state-related item with the correction information or the state-related item included in the history of the object detection information, more specifically, the information on the correction target state-related item (step ST12).

The reliability comparing unit 3052 outputs the information selected in the reliability comparing process to the object information generating unit 3053 as a reliability comparing result in association with information capable of specifying to which piece of correction target state-related item information in the object detection information the selected information corresponds.

On the basis of the determination result as to whether or not to correct the state-related item included in the object detection information acquired by the object detection information acquiring unit 301, more specifically, the information on the correction target state-related item with the correction information or the state-related item included in the history of the object detection information, more specifically, the information on the correction target state-related item, made by the reliability comparing unit 3052, the object information generating unit 3053 corrects the state-related item included in the object detection information, more specifically, the information on the correction target state-related item on the basis of the correction information or the state-related item included in the history of the object detection information, more specifically, the information on the correction target state-related item, and generates object information (step ST13).

The object information generating unit 3053 outputs the generated object information to the object information output unit 306.

An operation of the correction device 300 as described with reference to the flowchart of FIG. 4 will be described with an example of a specific application scene.

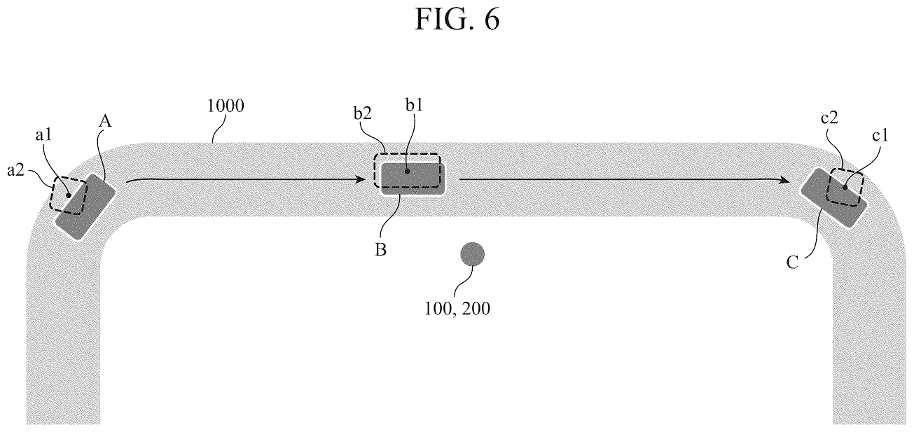

FIG. 6 is a diagram for explaining an example of the operation of the correction device 300 as described with reference to the flowchart of FIG. 4 in a case where the correction device 300 is applied in the above scene.

Note that, in the first embodiment so far, as an example, the object state information of the object detection information regarding an object detected by the sensor 100 includes information on four state-related items of a position of the object, a size of the object, an orientation of the object, and a type of the object, and among these pieces of information, the orientation of the object is used as the correction target state-related item. However, in the following description of an example of an application scene, the size of the object is used as the correction target state-related item. The size of the object can also be the correction target state-related item.

For object detection information regarding various objects detected in various scenes by the sensor 100 that detects the objects, the correction device 300 can correct various kinds of invariable information that are included in the object detection information and do not change depending on time, that is, various kinds of information that can be correction target state-related items, and generate object information.

In FIG. 6, it is assumed that a vehicle (indicated by A, B, or C in FIG. 6) is traveling on a road (indicated by 1000 in FIG. 6). The position of the vehicle indicated by A in FIG. 6 is a position at time T1, the position of the vehicle indicated by B in FIG. 6 is a position at time T2, and the position of the vehicle indicated by C in FIG. 6 is a position at time T3. For simplicity of explanation, FIG. 6 illustrates the vehicle at time T1, the vehicle at time T2, and the vehicle at time T3 together, but it is assumed that the vehicle moves from the position at time T1→the position at time T2→the position at time T3 in a time series manner. That is, although the vehicles illustrated in FIG. 6 are distinguished from each other by “A”, “B”, and “C” for ease of understanding, the vehicle indicated by “A”, the vehicle indicated by “B”, and the vehicle indicated by “C” are the same vehicle.

The sensor 100 is disposed on a road shoulder, and detects a vehicle. The detection unit 200 generates object detection information regarding a vehicle detected by the sensor 100, and outputs the object detection information to the correction device 300 (not illustrated in FIG. 6).

It is assumed that the sensor 100 detects the position of the vehicle (indicated by A in FIG. 6) as a position indicated by “a1” in FIG. 6 and detects the size of the vehicle as a size indicated by “a2” in FIG. 6 at time T1.

In addition, it is assumed that the sensor 100 detects the position of the vehicle (indicated by B in FIG. 6) as a position indicated by “b1” in FIG. 6 and detects the size of the vehicle as a size indicated by “b2” in FIG. 6 at time T2.

In addition, it is assumed that the sensor 100 detects the position of the vehicle (indicated by C in FIG. 6) as a position indicated by “c1” in FIG. 6 and detects the size of the vehicle as a size indicated by “c2” in FIG. 6 at time T3.

Note that, here, the position of the vehicle is represented by a center position of the vehicle.

As illustrated in FIG. 6, the vehicle indicated by “B” is sufficiently close to the sensor 100, and the sensor 100 can detect the size of the vehicle indicated by “B” without largely deviating from the actual size of the vehicle indicated by “B”.

For example, the vehicle is located far from the sensor 100 at time T1, and a distance from the sensor 100 to the vehicle is longer than a preset distance.

In this case, in the correction device 300, the first reliability corresponding to the size of the object, calculated by the reliability calculating unit 3051 of the correction unit 305, is lower than the second reliability corresponding to the size of the object. Note that, since there is no history of the object detection information at time T1, the reliability calculating unit 3051 does not calculate the third reliability. As described above, in a case where the history of the object detection information acquired by the object detection information acquiring unit 301 is not stored in the detection result holding unit 302, the reliability calculating unit 3051 does not calculate the third reliability.

The reliability comparing unit 3052 of the correction unit 305 determines that the information on the size of the vehicle included in the object detection information needs to be corrected on the basis of the information for correcting the size of the vehicle corresponding to the size of the vehicle included in the correction information, and selects the information for correcting the size of the vehicle. The reliability comparing unit 3052 outputs the selected information for correcting the size of the vehicle to the object information generating unit 3053 of the correction unit 305 as a reliability comparing result in association with information capable of specifying that the information is information corresponding to the size of the vehicle in the object detection information.

For the object detection information acquired by the object detection information acquiring unit 301, the object information generating unit 3053 corrects the information indicating the size of the vehicle included in the object detection information on the basis of the information for correcting the size of the vehicle included in the correction information, and uses the corrected object detection information as object information.

For example, at time T2, the vehicle approaches the sensor 100, and a distance from the sensor 100 to the vehicle is shorter than the preset distance. As a result, it is assumed that the sensor 100 can detect the vehicle with sufficiently high accuracy.

In this case, in the correction device 300, the first reliability corresponding to the size of the object, calculated by the reliability calculating unit 3051, is higher than the second reliability and the third reliability corresponding to the size of the object.

The reliability comparing unit 3052 determines that it is not necessary to correct the information on the size of the vehicle included in the object detection information, and outputs information indicating the determination to the object information generating unit 3053 as a reliability comparing result.

The object information generating unit 3053 does not correct the content of the object detection information acquired by the object detection information acquiring unit 301, and uses the object detection information as object information.

For example, at time T3, the vehicle is again located far from the sensor 100, and a distance from the sensor 100 to the vehicle is longer than the preset distance.

Meanwhile, the object detection information stored in the detection result holding unit 302 at time T2 is object detection information in which the sensor 100 and the vehicle are sufficiently close to each other and the sensor 100 can detect the vehicle with sufficiently high accuracy.

In this case, in the correction device 300, the third reliability corresponding to the size of the object, calculated by the reliability calculating unit 3051, is higher than the first reliability and the second reliability corresponding to the size of the object.

The reliability comparing unit 3052 determines that information on the size of the vehicle included in the object detection information needs to be corrected on the basis of information on the size of the vehicle included in the history of the object detection information, and selects the information on the size of the vehicle included in the history of the object detection information, more specifically, information on the size of the vehicle included in the object detection information acquired at time T2. The reliability comparing unit 3052 outputs the selected information on the size of the vehicle to the object information generating unit 3053 of the correction unit 305 as a reliability comparing result in association with information capable of specifying that the information is information corresponding to the size of the vehicle in the object detection information.

For the object detection information acquired by the object detection information acquiring unit 301, the object information generating unit 3053 corrects the information indicating the size of the vehicle included in the object detection information on the basis of the information on the size of the vehicle included in the correction information acquired at time T2, and uses the corrected object detection information as object information.

As described above, the correction device 300 acquires object detection information regarding an object detected by the sensor 100 in a target area, the object detection information including information on a state-related item related to a state of the object, corrects the information on the state-related item included in the object detection information on the basis of the acquired object detection information, correction information for correcting the information on the state-related item, and a history of the object detection information, and generates object information that is the corrected object detection information.

Therefore, the correction device 300 can correct object detection information obtained by the sensor 100 detecting an object to information having sufficient reliability to be used in a technique that performs various functions.

As described above, for example, in a case where sensor 100 arrangement intervals are sparse or in a case where a distance from the sensor 100 to an object is long, accuracy of object detection information obtained by the sensor 100 detecting the object may be low, and reliability of the object recognizable from the object detection information may be low.

For example, in object detection information obtained by a LiDAR detecting an object, an object located far away is represented by a small number of point clouds. For example, in object detection information obtained by a camera detecting an object, an object located far away is represented by a small number of pixels. As a result, it may be difficult to recognize an object on the basis of the object detection information. That is, the object detection information may be information with low accuracy.

Meanwhile, as described above, the correction device 300 according to the first embodiment corrects the information on the state-related item included in the object detection information on the basis of the acquired object detection information, correction information for correcting the information on the state-related item, and a history of the object detection information, and generates object information that is the corrected object detection information.

Therefore, the correction device 300 can correct object detection information obtained by the sensor 100 detecting an object to information having sufficient reliability to be used in a technique that performs various functions.

Note that, in the above first embodiment, the correction device 300 stores the history of the object detection information acquired from the detection unit 200, and corrects the object detection information acquired from the detection unit 200 using also the history of the object detection information.

However, this is merely an example, and the correction device 300 does not necessarily use the history of the object detection information when correcting the object detection information acquired from the detection unit 200.

For example, in a case where there is no history of the object detection information, the correction device 300 only needs to correct the object detection information acquired from the detection unit 200 without using the history, or the correction device 300 may be configured not to have a function of storing the history of the object detection information. In this case, the correction device 300 does not necessarily include the detection result holding unit 302.

That is, the correction device 300 may be configured to acquire object detection information, to correct information on a state-related item included in the object detection information on the basis of the acquired object detection information and correction information for correcting the information on the state-related item, and to generate object information that is the corrected object detection information.

Even with such a configuration, the correction device 300 can correct object detection information obtained by the sensor 100 detecting an object to information having sufficient reliability to be used in a technique that performs various functions. In the above first embodiment, the correction information holding unit 304 stores the correction information, and the correction information may include only information for correcting the information on the correction target state-related item. In this case, in the correction device 300, the correction unit 305 only needs to directly acquire the correction information from the correction information holding unit 304, and the correction device 300 may be configured not to include the correction information acquiring unit 303.

In addition, in the above first embodiment, it is assumed that the correction device 300 is mounted on a server (not illustrated), but this is merely an example.

For example, the correction device 300 may be mounted on the sensor 100, or the detection unit 200 and the correction device 300 may be mounted on a common device. The detection unit 200 may be included in the correction device 300.

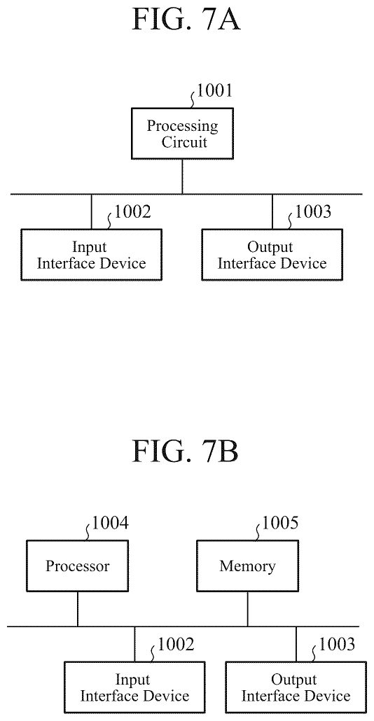

FIGS. 7A and 7B are each a diagram illustrating an example of a hardware configuration of the correction device 300 according to the first embodiment.

In the first embodiment, functions of the object detection information acquiring unit 301, the correction information acquiring unit 303, the correction unit 305, and the object information output unit 306 are implemented by a processing circuit 1001. That is, the correction device 300 includes the processing circuit 1001 for performing control to correct object detection information regarding an object detected by the sensor 100.

The processing circuit 1001 may be dedicated hardware as illustrated in FIG. 7A, or a processor 1004 that executes a program stored in a memory as illustrated in FIG. 7B.

In a case where the processing circuit 1001 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 1001.

In a case where the processing circuit is the processor 1004, the functions of the object detection information acquiring unit 301, the correction information acquiring unit 303, the correction unit 305, and the object information output unit 306 are implemented by software, firmware, or a combination of software and firmware. Software or firmware is described as a program and stored in a memory 1005. The processor 1004 executes the functions of the object detection information acquiring unit 301, the correction information acquiring unit 303, the correction unit 305, and the object information output unit 306 by reading and executing the program stored in the memory 1005. That is, the correction device 300 includes the memory 1005 for storing a program that causes steps ST1 to ST4 of FIG. 4 described above to be executed as a result when the program is executed by the processor 1004. It can also be said that the program stored in the memory 1005 causes a computer to execute procedures or methods of processes performed by the object detection information acquiring unit 301, the correction information acquiring unit 303, the correction unit 305, and the object information output unit 306. Here, for example, a nonvolatile or volatile semiconductor memory such as RAM, read only memory (ROM), flash memory, erasable programmable read only memory (EPROM), or electrically erasable programmable read-only memory (EEPROM); a magnetic disk, a flexible disk, an optical disc, a compact disc, a mini disc, or a digital versatile disc (DVD) corresponds to the memory 1005.

Note that some of the functions of the object detection information acquiring unit 301, the correction information acquiring unit 303, the correction unit 305, and the object information output unit 306 may be implemented by dedicated hardware, and some of the functions may be implemented by software or firmware. For example, the functions of the object detection information acquiring unit 301 and the correction information acquiring unit 303 can be implemented by the processing circuit 1001 as dedicated hardware, and the functions of the correction unit 305 and the object information output unit 306 can be implemented by the processor 1004 reading and executing a program stored in the memory 1005.

For the detection result holding unit 302 and the correction information holding unit 304, for example, the memory 1005 is used. Note that this is an example, and the detection result holding unit 302 and the correction information holding unit 304 may be constituted by an HDD, a solid state drive (SSD), or the like.

The correction device 300 includes an input interface device 1002 and an output interface device 1003 that perform wired communication or wireless communication with a device such as the sensor 100.

As described above, according to the first embodiment, the correction device 300 includes: the object detection information acquiring unit 301 that acquires object detection information regarding an object detected by the sensor 100 in a target area, the object detection information including information on a state-related item related to a state of the object; the correction unit 305 that corrects the information on the state-related item included in the object detection information on the basis of the object detection information acquired by the object detection information acquiring unit 301 and correction information for correcting the information on the state-related item, and generates object information that is the corrected object detection information; and the object information output unit 306 that outputs the object information generated by the correction unit 305. Therefore, the correction device 300 can correct object detection information obtained by the sensor 100 detecting an object to information having sufficient reliability to be used in a technique that performs various functions.

Note that, in the present disclosure, any component in the embodiment can be modified, or any component in the embodiment can be omitted.

### REFERENCE SIGNS LIST

100: sensor, 200: detection unit, 300: correction device, 301: object detection information acquiring unit, 302: detection result holding unit, 303: correction information acquiring unit, 304: correction information holding unit, 305: correction unit, 3051: reliability calculating unit, 3052: reliability comparing unit, 3053: object information generating unit, 306: object information output unit, 30: correction system, 1001: processing circuit, 1002: input interface device, 1003: output interface device, 1004: processor, 1005: memory

1. A correction device comprising:
processing circuitry performing:
to acquire object detection information regarding an object detected by a sensor in a target area, the object detection information including information on a state-related item related to a state of the object;
to correct the information on the state-related item included in the object detection information on a basis of the object detection information acquired and correction information for correcting the information on the state-related item, and to generate object information that is the corrected object detection information; and
to output the object information generated.

2. The correction device according to claim 1, wherein
the processing circuitry further performs:
to calculate first reliability that is reliability of the information on the state-related item included in the object detection information acquired and second reliability that is reliability of the correction information;
to compare the first reliability and the second reliability calculated with each other, and to determine whether or not to correct the information on the state-related item included in the object detection information with the correction information; and
to correct, on a basis of a determination result as to whether or not to correct the information on the state-related item included in the object detection information with the correction information, the information on the state-related item included in the object detection information on a basis of the correction information, and to generate the object information.

3. The correction device according to claim 1, wherein
the processing circuitry corrects the information on the state-related item included in the object detection information on a basis of the object detection information acquired, the correction information, and a history of the object detection information acquired, and generates the object information.

4. The correction device according to claim 3, wherein
the processing circuitry further performs:
to calculate first reliability that is reliability of the information on the state-related item included in the object detection information acquired, second reliability that is reliability of the correction information, and third reliability that is reliability of the information on the state-related item included in the history of the object detection information;
to compare the first reliability, the second reliability, and the third reliability calculated with each other, and to determine whether or not to correct the information on the state-related item included in the object detection information with the correction information or the information on the state-related item included in the history of the object detection information; and
to correct, on a basis of a determination result as to whether or not to correct the information on the state-related item included in the object detection information with the correction information or the information on the state-related item included in the history of the object detection information, the information on the state-related item included in the object detection information on a basis of the correction information or the information on the state-related item included in the history of the object detection information, and to generate the object information.

5. The correction device according to claim 1, wherein
there is a plurality of the state-related items, and
the processing circuitry corrects the object detection information by selecting, for each of the state-related items, whether to keep the information on the state-related item of the object detection information as the information on the state-related item as it is or to convert the information on the state-related item of the object detection information into information based on the correction information, and generates the object information.

6. The correction device according to claim 3, wherein
there is a plurality of the state-related items, and
the processing circuitry corrects the object detection information by selecting, for each of the state-related items, whether to keep the information on the state-related item of the object detection information as the information on the state-related item as it is, to convert the information on the state-related item of the object detection information into information based on the correction information, or to convert the information on the state-related item of the object detection information into information on the state-related item included in the history of the object detection information, and generates the object information.

7. A non-transitory tangible computer readable storage medium storing a correction program for causing a computer
to function as the correction device according to claim 1.

8. A correction system comprising:
the correction device according to claim 1; and
the sensor to detect the object present in the target area.

9. The correction system according to claim 8, wherein
the sensor is a radio wave sensor to detect the object by detecting reflected light that is obtained by light emitted into the target area being reflected by the object.

10. The correction system according to claim 8, wherein
the sensor is a camera to image the target area.
